(19) United States
(12) Patent Application Publication
(10) Pub. No.: US 2026/0154953 A1
(43) Pub. Date: Jun. 4, 2026

(54) COMPUTER VISION LEARNING AND OBJECT DETECTION FOR LONG-TAILED DATA DISTRIBUTIONS

(71) Applicant: LEXISNEXIS RISK SOLUTIONS FL INC., Boca Raton, FL (US)

(72) Inventor: Phi Vu Tran, Riverside, CA (US)

(21) Appl. No.: 19/172,080

(22) Filed: Apr. 7, 2025

Related U.S. Application Data
(60) Provisional application No. 63/727,882, filed on Dec. 4, 2024.

(51) Int. Cl. G06V 10/82; G06V 10/774

(52) U.S. Cl. CPC G06V 10/82; G06V 10/7753

(57) ABSTRACT

Systems and methods are provided for long-tailed distribution object detection that utilizes a streamlined framework using multi-stage supervised and/or semi-supervised training. The disclosed technology eliminates reliance on extensive labeled datasets by effectively utilizing unlabeled data through pseudo-labeling and robust augmentation techniques. The disclosed technology enhances detection accuracy across both frequent and rare categories without introducing unnecessary complexities such as knowledge distillation or meta-learning. Certain implementations of the disclosed technology include multi-stage training with external unlabeled images. Certain implementations of the disclosed technology include pre-training a model on the (frequent) head classes and learning is transferred to the (rare) tail classes, which provides significant benchmarking improvements over other approaches.

### CROSS REFERENCE TO RELATED APPLICATIONS

This application claims priority to U.S. Provisional Patent Application No. 63/727,882, filed 4 Dec. 2024, the contents of which are incorporated herein by reference as if presented in full.

### FIELD OF THE INVENTION

The disclosed technology relates to object detection in computer vision. More specifically, it pertains to techniques for handling long-tailed data distributions using supervised and semi-supervised learning approaches.

### BACKGROUND

Despite tremendous advances in modern visual recognition systems, many vision models struggle with the problem of learning object detection when few training exemplars are available and/or when datasets exhibit significant class imbalances. In situations where object classes follow a natural long-tailed distribution, existing approaches rely on external labels (such as via ImageNet) to augment low-shot training instances, large-scale labeled datasets, or complex multi-stage training paradigms, which may introduce inefficiencies or fail to scale to practical applications. The dependency on such large, labeled databases is impractical and has limited utility in realistic scenarios. Previous research on multi-stage training involved an overly complex and cumbersome process, yielding inferior results. The need exists for a simplified yet effective solution to address long-tailed distributions in detection tasks.

### BRIEF SUMMARY

Embodiments of the disclosed technology include systems and methods for long-tailed distribution object detection that utilizes a streamlined framework using multi-stage supervised and/or semi-supervised training. The disclosed technology eliminates reliance on extensive labeled datasets by effectively utilizing unlabeled data through pseudo-labeling and robust augmentation techniques. The disclosed technology enhances detection accuracy across both frequent and rare categories without introducing unnecessary complexities such as knowledge distillation or meta-learning.

In accordance with certain exemplary implementations of the disclosed technology, a computer-implemented method is provided for long-tailed object detection. The method can include obtaining a dataset with labeled head classes appearing in more than a threshold number of samples and labeled tail classes appearing in fewer than the threshold number of samples, pre-training a detection model on head class images of the dataset, wherein the detection model can include a backbone network for feature extraction, and a detection head comprising a classifier module and a regressor module for bounding box predictions. The method can further include augmenting the pre-trained detection model by pseudo-labeling unlabeled images and adapting the detection model to tail classes by initializing tail parameters of the detection model from the pre-trained head detection model and fine-tuning with tail class images, and fine-tuning the detection model on a balanced dataset comprising both head and tail classes, wherein the fine-tuning updates the classifier module and the regressor module while freezing parameters of the backbone network.

In accordance with certain exemplary implementations of the disclosed technology, a computer system is disclosed for long-tailed object detection. The system includes a memory storing a dataset with labeled head classes, labeled tail classes, and unlabeled images; and a processing unit executing instructions to pre-train a detection model on head class images by optimizing feature extraction and detection head components, generate pseudo-labels for unlabeled images using a teacher model, wherein the pseudo-labels are filtered based on confidence scores, augment tail class training data by copying and pasting rare class instances onto diverse background images; fine-tune the detection model on a balanced dataset including sampled head and tail class images; and merge and unify head and tail class detection parameters into a single inference model.

In accordance with certain exemplary implementations of the disclosed technology, a non-transitory computer-readable medium is disclosed for storing instructions that, when executed by a processor, cause a system to perform a method of obtaining a dataset with labeled head classes appearing in more than a threshold number of samples and labeled tail classes appearing in fewer than the threshold number of samples, pre-training a detection model on head class images of the dataset, wherein the detection model can include a backbone network for feature extraction, and a detection head with classifier and regressor modules for bounding box predictions. The method can further include augmenting the pre-trained detection model by pseudo-labeling unlabeled images and adapting the detection model to tail classes by initializing tail parameters of the detection model from the pre-trained detection model and fine-tuning with tail class images, and fine-tuning the detection model on a balanced dataset comprising both head and tail classes, wherein the fine-tuning updates the classifier and regressor modules while freezing parameters of the backbone network.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE DRAWINGS

Reference will now be made to the accompanying figures and flow diagrams, which are not necessarily drawn to scale.

FIG. 1 illustrates a survey of the recent state of the art on long-tailed detection in relation to the disclosed technology, which achieves superior results on the LVIS v1 benchmark without requiring auxiliary image-level supervision.

FIG. 2 illustrates the motivation for the disclosed technology, including an improved head-to-tail model transfer framework for long-tailed detection by incorporating unlabeled images in both representation and transfer learning stages. While it is possible to find more samples of LVIS instances from ImageNet, such an auxiliary database may not exist in another scenario like aerial imagery. Implementations of the disclosed framework does not depend on using extra image-level labels to advance long-tailed detection, which expands the practical utility of the disclosed approach beyond LVIS.

FIG. 3A illustrates a model and detector for pre-training on head classes with unlabeled images, in accordance with certain exemplary implementations of the disclosed technology.

FIG. 3B illustrates the head representations (from FIG. 3A) may be transferred to tail classes, in accordance with certain exemplary implementations of the disclosed technology.

FIG. 3C illustrates the detector may be fine-tuned on a sampled set of head and tail classes (from FIG. 3B), in accordance with certain exemplary implementations of the disclosed technology. In this example implementation, the “model” may include a block of encoder-decoder transformations based on either a convolutional or Transformer network. In certain implementations, the model may be updated only during pre-training.

FIG. 4 illustrates an example transfer learning from COCO representations (solid bars) that helps improve rare class detection on LVIS (hatched bars).

FIG. 5A illustrates the impact of the disclosed technique on pseudo-labeling and illustrates augmenting unlabeled images by randomly pasting rare instances from the training set, which helps promote pseudo-labeling for semi-supervised LTD.

FIG. 5B illustrates examples of the augmented unlabeled images, which are subjected to strong photometric and geometric perturbations with cutout.

FIG. 5C illustrates additional examples of the augmented unlabeled images, which are subjected to strong photometric and geometric perturbations with cutout. T

FIG. 5D illustrates that utilization of the rare instances can improve robustness and generalization on natural scenes (boxes).

FIG. 6A illustrates detections using the disclosed technology on LVIS v1 validation images for k=1 shot. Visualizations containing truly rare k-shot exemplars (subwoofer equipment in this case) from the training set are highlighted in the dashed-boxes. The disclosed technology performs well in the extremely low-shot regime using as few as a single training instance.

FIG. 6B illustrates detections using the disclosed technology on LVIS v1 validation images for k=3 shots. A visualization containing a truly rare k-shot exemplar (martini in this case) from the training set is highlighted in the dashed-box.

FIG. 6C illustrates detections using the disclosed technology on LVIS v1 validation images for k=4 shots. A visualization containing a truly rare k-shot exemplar (cocoa beverage in this case) from the training set is highlighted in the dashed-box.

FIG. 6D illustrates detections using the disclosed technology on LVIS v1 validation images for k=5 shots. A visualization containing a truly rare k-shot exemplar (Sharpie pen in this case) from the training set is highlighted in the dashed-box.

FIG. 7A illustrates evaluation on Objects365 binned by the count of training images per class group. All models use the ResNet-50 backbone.

FIG. 7B shows that the disclosed technology outperforms the existing baseline across the board in the validation results.

FIG. 8A illustrates ablation experiments assessing the performance impact of the disclosed technology from transfer learning on tail classes, in accordance with certain exemplary implementations.

FIG. 8B illustrates ablation experiments assessing the performance impact of the disclosed technology by varying the number of sampled shots for fine-tuning with Dₖ, in accordance with certain exemplary implementations.

FIG. 9 is a flow diagram of a method in accordance with certain exemplary implementations of the disclosed technology.

FIG. 10 show results of LVIS v1 validation in accordance with certain exemplary implementations of the disclosed technology. with GPU hours denoting wall clock time to train for a total of 640K iterations and are a proxy measure of model complexity. The ResNet and Swin backbones were pre-trained on ImageNet-1K and ImageNet-22K, respectively. The results of Seesaw Loss and Detic are borrowed from EFL and RichSem, respectively. Shaded rows indicate our implemented models

Various features of the technology described herein will become more apparent to those skilled in the art from a study of the Detailed Description in conjunction with the drawings. Those skilled in the art will recognize that alternative embodiments may be employed without departing from the principles of the technology. Accordingly, although specific embodiments are shown in the drawings, the technology is amenable to various modifications.

### DETAILED DESCRIPTION

The disclosed technology includes systems and methods that can enable an improved long-tailed distribution object detection that utilizes a streamlined framework using multi-stage supervised and/or semi-supervised training that can involve pre-training a model on the head classes and then perform transfer learning on the tail classes.

Certain implementations of the disclosed technology include a simplified multi-stage training framework for effective long-tailed detection. Unlike existing multi-stage approaches, the framework in the disclosed technology allows for the use of optional unlabeled images for semi-supervised long-tailed detection. Certain implementations of the disclosed technology include a technique of pasting rare instances from the training set to the unlabeled images. Unlike existing approaches that use extra external data, the disclosed technology does not depend on any additional human annotations at either the image level (i.e., whole-image labels from ImageNet) or instance level (i.e., bounding boxes). Certain implementations of the disclosed technology may use only a human-labeled training set (like other methods) along with unlabeled images which are collected in the wild and are not labeled by a human in any way. When put to the test against competing methods on the challenging LVIS v1 benchmark, the disclosed technology establishes new state-of-the-art results across both supervised and semi-supervised settings without the need for additional image level labels.

In certain implementations, the framework can include representation learning on frequent head classes, optionally incorporating unlabeled data for improved feature extraction; transfer learning on rare tail classes using pre-trained head representations, adapted with fine-tuning on augmented datasets; and unified detector fine-tuning on a balanced subset of head and tail classes.

The disclosed technology may be viewed as an improved head-to-tail model transfer paradigm without requiring added complexities of meta-learning or knowledge distillation. By harnessing supplementary unlabeled images without the need for extra image labels, the disclosed technology can provide improved benchmarks across both supervised and semi-supervised settings.

Certain implementations of the disclosed technology can utilize Pseudo-Labeling: Unlabeled images, which are pseudo-labeled during training. The pseudo-labels may be derived from a teacher model, ensuring the effective learning of rare categories. Certain implementations of the disclosed technology can include Data Augmentation: Copy-Paste augmentation, which can ensure balanced training samples across head and tail distributions. Additional geometric and photometric augmentations may be utilized to enhance robustness. Certain implementations of the disclosed technology include may be compatible with convolutional and Transformer-based architectures, providing scalability across hardware and dataset configurations. Certain implementations of the disclosed technology may achieve state-of-the-art results on benchmarks like LVIS v1 and Objects365 without auxiliary image-level labels.

The unique approach of the disclosed technology is distinguished over previous methods in that the disclosed technology does not rely on any other labels besides the ones provided by the training set. In comparison, methods like RichSem, Detic, and MosaicOS all require additional human annotated labels from the external ImageNet database to augment their training protocols. The disclosed technology can leverage unlabeled images collected in the wild that have no human annotations attached to them. During training, the disclosed technology can produce pseudo-labels. Furthermore, rare instances may be pasted on unlabeled images in an algorithmic manner without manual intervention from a human. By comparison, methods (such as CascadeMatch) that perform single-stage training with unlabeled images results in worse performance compared to the multi-stage stage training with unlabeled images disclosed herein.

Certain implementations of the disclosed technology may be further understood and supported by the following description and figures.

The task of detecting, localizing, and classifying object instances in images and video is a long-standing problem in computer vision that may be solved using certain implementations of the disclosed technology. The recent progress in modern object detection systems, prior to this disclosure, has been mostly driven by models that rely on powerful neural architectures and measured on the relatively balanced, small vocabulary benchmarks, such as PASCAL VOC or MS-COCO. However, when evaluated on a more complex and imbalanced dataset with a much larger vocabulary, the same models exhibit a considerable drop in detection accuracy.

Certain implementations of the disclosed technology can enhance the capability of commodity detection systems, with a particular evaluation emphasis on the challenging large-vocabulary LVIS benchmark, which can represent a realistic scenario in which object classes follow a natural long-tailed distribution. It is in the tail portion of the long-tailed distribution that most data-hungry models struggle with performance since such distribution can be characterized by many rare classes having as few as a single training exemplar.

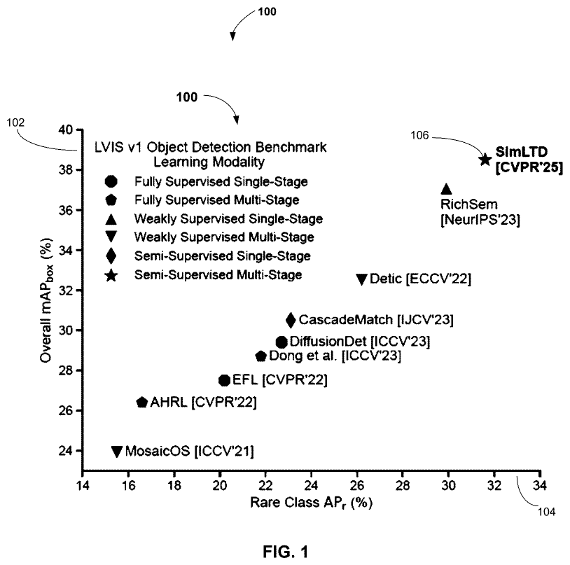

FIG. 1 is a plot 100 of recognition performance 102 vs. class rarity 104 for recent state-of-the-art methods developed to address the extreme disparity of class distributions in long tailed detection (LTD). The disclosed technology (represented by the “SimLTD” benchmark datapoint 106 in the upper right-hand corner of FIG. 1) can utilize a process of combining unlabeled data with an intuitive multi-stage training strategy (as will be discussed further below) to deliver superior overall performance while also optimizing for accuracy on rare classes. The disclosed technology can achieve the superior results on the LVIS v1 benchmark without requiring auxiliary image-level supervision.

In comparison, previous approaches have utilized segmentation of the overall dataset into several phases, each phase containing progressively smaller but balanced data samples. In such previous approaches, a model may be trained in an incremental manner via network expansion and knowledge distillation. However, such previous methods can be overly complex, requiring maintenance of many sub-parts and numerous stages of knowledge transfer that can lead to catastrophic forgetting, resulting in an inferior solution.

Other previous approaches have attempted to leverage external data to augment the training instances in LVIS. However, such previous approaches require access to a large database of labeled images across thousands of object classes, which is not necessarily suitable for many practical settings outside of LVIS.

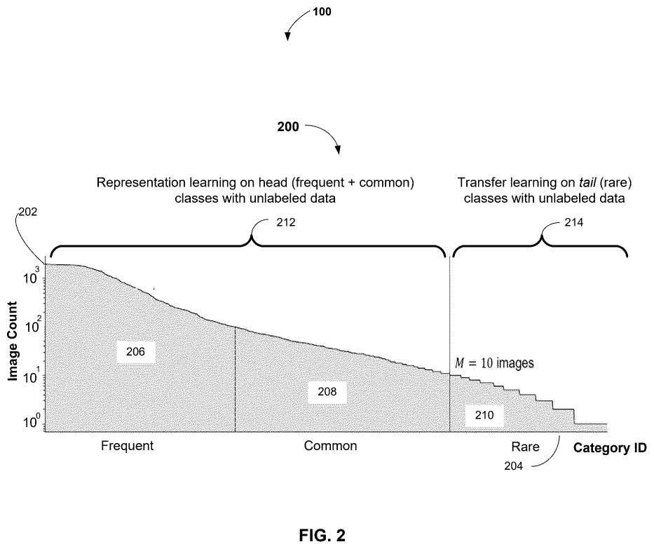

FIG. 2 is an example plot of a long tail distribution 200 of image count 202 vs. category 204 for an example of aerial imagery, including frequent 206, common 208, and rare 210 classes with unlabeled data. The example distribution plot 200 may be divided into head classes 212, which can include the frequent 206 and common 208 classes, and a tail classes 214 that can include the rare classes 210. In certain implementations, representation learning can be performed on the head classes 212, with learning transferred to the tail classes 214.

In certain implementations, an industry application could focus on well-defined and readily available general objects (such as may be represented in the head classes 212), however, building a new object-centric dataset to supplement the main training dataset can be costly and time-consuming. Furthermore, there is an existing challenge for how to handle genuinely rare unlabeled classes 210 (e.g., a rare fish species), which may be strictly limited in observation and with limited availability.

In accordance with certain exemplary implementations of the disclosed technology, a new framework and/or process may be utilized to that generally involves (i) pre-training on head classes 212, (ii) transfer learning on tail classes 214, and (iii) fine-tuning on a small, sampled set composed of both head classes 212 and tail classes 214. Certain implementations of the disclosed technology allow for the use of unlabeled images to further boost results. In accordance with certain exemplary implementations of the disclosed technology, learning can be achieved with supplementary unlabeled data in a semi-supervised manner via pseudo-labeling and therefore do not explicitly rely on any additional instance-level or image-level supervision.

Certain implementations of the disclosed technology may address several challenges associated with the head-to-tail model transfer paradigm. For example, the traditional transfer of data-rich head representations to data-scarce tail classes may not yield sufficient performance improvement when the distribution of head classes is also skewed. Moreover, the naïve application of unlabeled data can aggravate a model's inductive bias because the unlabeled samples may follow a similar long-tailed distribution. In such cases, the trained model may tend to generate more pseudo labels for the head classes, resulting in more pseudo-class imbalance.

The disclosed technology may overcome the above-referenced obstacles by incorporating data augmentations specifically designed to mitigate class imbalances in both head and tail training stages. Extensive experiments show that stronger pre-trained models on head classes, with and without unlabeled images, transfer well to the tail classes, leading to a desired solution for long-tailed detection.

The disclosed technology provides a general and versatile framework for effective semi-supervised long tailed distributions with unlabeled images that may utilize straightforward and intuitive processes compatible with a range of backbones and detectors based on both classical convolutional and modern transformer architectures. When put to the test against competing methods on the challenging LVIS v1 benchmark, the disclosed technology demonstrates excellent performance and scalability, establishing new state-of-the-art results by compelling margins.

Certain implementations of the disclosed technology may leverage pre-trained representations to provide better initialization than random weights for fine-tuning on tail classes. Certain implementations of the disclosed technology may take a different but related approach of pre-training on the frequent and common head instances, where head representations are copied and fine-tuned on the tail classes without resorting to knowledge distillation or meta-learning, as was required in traditional methods. Of note, the disclosed technology may utilize three stages of learning compared to the seven stages of previous techniques, which can exacerbate catastrophic forgetting. It is worth repeating that a novel component of the disclosed technology is the introduction of unlabeled images in both pre-training and transfer learning stages for enhanced LTD, leading to a more general and flexible solution to use unlabeled data as a source of auxiliary supervision, which is easy to collect without the burden of human annotations, and which can be more effective than competing solutions due to the multi-stage training strategy, as will be further discussed below.

Long-tailed detection (LTD) is related to the task of few-shot detection (FSD), the purpose of which is to adapt a base detector (trained on many-shot instances) to learn new concepts from few-shot exemplars. Both tasks aim to boost detection on categories with very few training instances. However, LTD has unique challenges that extend beyond FSD. For LTD, the tail classes are authentically rare and follow a Zipf distribution in natural scenes. By contrast, the novel few-shot exemplars in FSD datasets are randomly sampled and are not necessarily rare but can include objects of varying degrees of observational frequency. As such, the multi-stage training methods that work well for FSD cannot be directly applied to LTD with the same expected level of effectiveness. The disclosed technology provides certain adaptations to the LTD problem to bring improvement over the state of the art.

With continued reference to FIG. 2, given a long-tailed dataset Dₗₜ 200 with C categories 204, the dataset Dₗₜ 200 may be split it into two disjoint subsets: D_{head} 212 with C_{head} frequent and common categories appearing in >M images, and Dₜₐᵢₗ 214 with Cₜₐᵢₗ rare classes appearing in ≤M images. An unlabeled dataset Dᵤ of unknown class distribution may be available. In certain implementations, a goal is to use a combination of labeled and unlabeled images to train a unified model optimized for accuracy on a test set comprising both classes in C_{head}∪Cₜₐᵢₗ.

The disclosed technology may utilize a framework that includes: (i) representation learning on D_{head}, (ii) transfer learning on Dₜₐᵢₗ, and (iii) fine-tuning on Dₖ, which is a reduced dataset composed of k instances per class randomly sampled from Dₗₜ. Note that D_{head}, Dₜₐᵢₗ, and Dₖ are all still imbalanced, but not as severe as the original long-tailed Dₗₜ. Optional unlabeled images in both Steps 1 and 2 may be leveraged but are not explicitly needed for effective LTD. Experiments show that fully supervised baselines still exhibit excellent performance and scalability without unlabeled data.

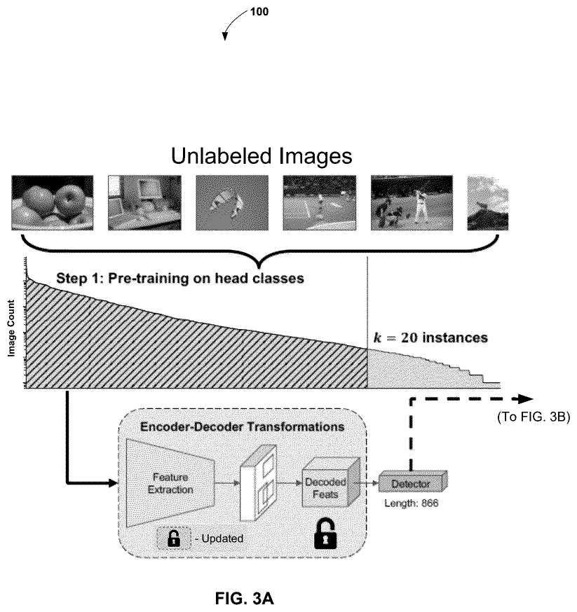

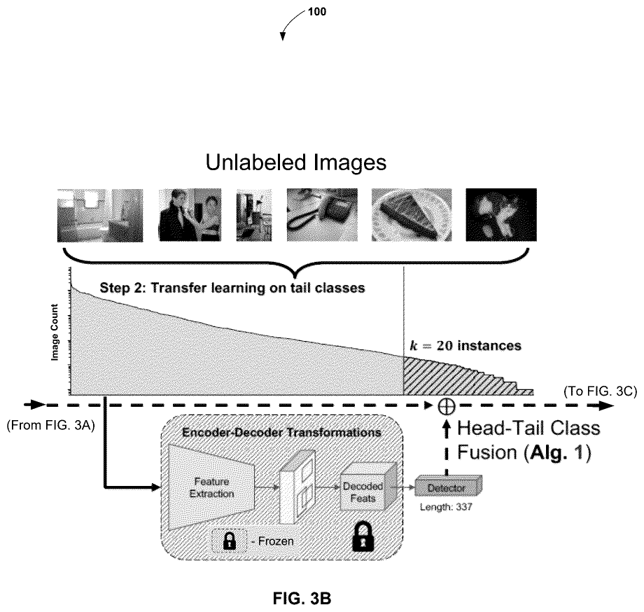

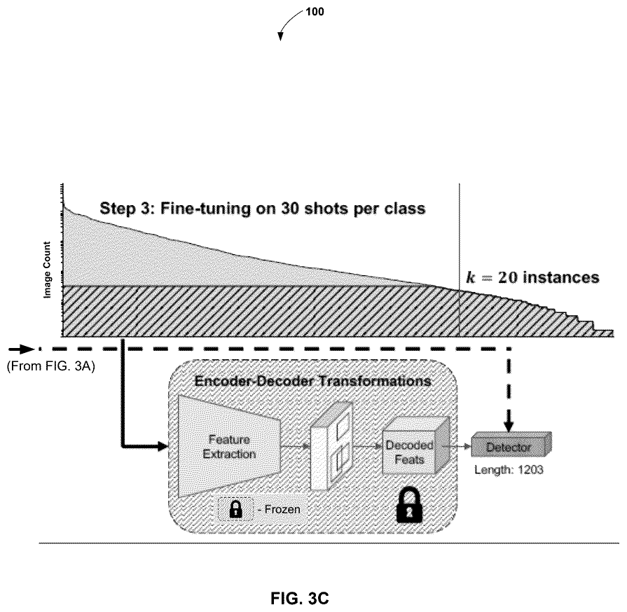

FIGS. 3A-3C illustrate three main example steps of the disclosed technology. The “model” discussed with reference to these figures may include a block of encoder-decoder transformations based on either a convolutional or transformer network. In certain implementations, the model may be updated only during pre-training, and frozen otherwise.

FIG. 3A a first step (Step 1) of an example training process, which can include pre-training a model 302 and detector 304 for head classes 306 with unlabeled images 308, in accordance with certain exemplary implementations of the disclosed technology. The output of the detector 304 may be utilized in the next step, as illustrated in FIG. 3B.

FIG. 3B illustrates a second step (Step 2) of the example training process, where the model 302 may be frozen, and the head representations training (from FIG. 3A) may be transferred to tail classes 310, in accordance with certain exemplary implementations of the disclosed technology. The example head-tail class fusion may be processed according to an algorithm, as will be discussed below with reference to a learnable detection function training Ψ_{det}(D_{head}) on the image-target pairs, as will be discussed below.

FIG. 3C illustrates a third step (Step 3) of the example training process, in which the detector 304 may be fine-tuned on a sampled set 312 of head and tail classes, in accordance with certain exemplary implementations of the disclosed technology. It should be understood that the example k instances (20 in this example) and number of shots (30 in this example) are for illustration, and other values may be utilized.

One of the open challenges of the LTD problem remains in learning and training an effective model on the few exemplars associated with the tail classes. Empirical analysis was utilized to verify that few-shot learning can vastly benefit from pre-trained representations in the LVIS setting. For example, following a conventional LVIS protocol, an example dataset was partitioned into C_{head}=866 common classes appearing in M>10 images, with Cₜₐᵢₗ=337 rare classes appearing in M≤10 images to determine improvements in the detection performance on Cₜₐᵢₗ using various commodity detectors pre-trained on a COCO dataset.

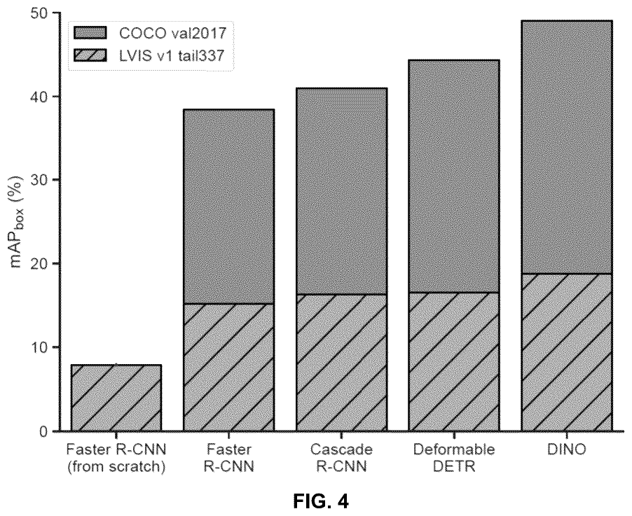

FIG. 4 shows effectiveness of pre-trained representations on Cₜₐᵢₗ detection. For each model, the detection head consisting of the bounding box classifier and regressor modules learned on the COCO dataset was chopped off, re-initialized with random values, and performed transfer learning on the LVIS tail classes. Only the box classifier and regressor was updated while keeping the rest of the architecture frozen, essentially treating the pre-trained model as a fixed detector. Besides the pre-trained networks, a Faster R-CNN detector initialized from scratch was assessed, except for the pre-trained backbone, as the lower-bound baseline. FIG. 4 illustrates a clear trend indicating stronger pre-trained representations, as measured by the AP score on COCO, that generally lead to improved rare class detection. This result is surprising since the models were pre-trained on COCO, a dataset of smaller scope and size than LVIS. As indicated in FIG. 4, training from scratch may bring out the worst performance with half of the accuracy. The implication of this experiment is two-fold: (1) we verify that low-shot learning can be improved with transferred representations; and (2) the disclosed technology opens up opportunities to self-supervised, semi-supervised, and multimodal learning, all of which have demonstrated significantly better performance than supervised pre-training. This indicates that the disclosed technology can learn powerful representations on D_{head} and transfer them to Dₜₐᵢₗ for long-tailed detection, while the previous attempts at head-to-tail model transfer would only work by incorporating an extra module for meta-learning or knowledge distillation. The details of the three-step approach (as illustrated in FIGS. 3A-3B) to accomplish the long-tailed detection (without the added complexities of previous methods) will now be discussed below.

Referring again to FIG. 3A, the first step of a training process can begin with the supervised setting using training data points (xᵢ, yᵢ)∈D_{head}, where xᵢ denotes the i-th input image and yᵢ is the i-th ground truth annotation containing the box label and coordinates. Let Ψ_{det}(D_{head}) is defined as a learnable detection function training on the image-target pairs to produce the supervised loss Lₛᵤₚ:

$${Ψ}_{det} ( {𝒟}_{head} ) ← {ℒ}_{sup} = \sum {L}_{cls} ( h ( {x}_{i} ) , {y}_{i} ) + {L}_{reg} ( h ( {x}_{i} ) , {y}_{i} ) . \qquad ( 1 )$$

Here, h(xᵢ) denotes the forward pass on the input image and (L_{cls}, L_{reg}) are classification (e.g., cross-entropy) and regression (e.g., L₁) losses for the detector. Commodity convolutional and transformer-based networks may be considered for Ψ_{det}. For the convolutional network, a Faster R-CNN may be compared against previous studies using similar detectors (i.e., Mask R-CNN and RetinaNet). For the contemporary transformer-based network, improved variants of the Detection Transformer (DETR) may be adopted, namely Deformable DETR and DINO.

TABLE 1

| Augmentation | Supervised Training | Semi-Supervised Training |
|---|---|---|
| Resize | short edge ∈ [400, 1200] | short edge ∈ [400, 1200] |
| Flip | horizontal | horizontal |
| SCP with RFS | sample threshold = 0.001 | sample threshold = 0.001 |
| AutoContrast | ✓ | ✓ |
| Equalize | ✓ | ✓ |
| Solarize | ✓ | ✓ |
| Color Jittering | ✓ | ✓ |
| Contrast | ✓ | ✓ |
| Brightness | ✓ | ✓ |
| Sharpness | ✓ | ✓ |
| Posterize | ✓ | ✓ |
| Translation | X | (x, y) ∈ (−0.1, 0.1) |
| Shearing | X | (x, y) ∈ (−30°, 30°) |
| Rotation | X | angle ∈ (−30°, 30°) |
| Cutout | X | n ∈ [1, 5], size ∈ [0.0, 0.2] |

As summarized in Table 1, data augmentations may be leveraged to train Ψ_{det} which include random image resizing, horizontal flipping, and photometric distortion. In certain implementations, a Simple Copy-Paste (SCP) together with Repeat Factor Sampling (RFS) may be utilized to combat the class imbalance in D_{head} at both the image and instance levels for image and instance resampling for LTD. Stronger representations on D_{head} may be learned in certain implementations by training Ψ_{det} in a semi-supervised manner with unlabeled images by way of pseudo-labeling. For example, certain implementations may utilize methods of increasing effectiveness to advance semi-supervised representation learning on D_{head}, which can include SoftER Teacher, MixTeacher, and/or MixPL. SoftER Teacher, for example, builds upon the end-to-end pseudolabeling approach of Soft Teacher to include an auxiliary loss for consistency learning on region proposals, and was shown to work particularly well with semi-supervised fewshot detection. MixTeacher, for example, introduces a mixed scale feature pyramid to generate more accurate pseudo labels on objects with extreme scale variations, resulting in an overall robust detector. While SoftER Teacher and MixTeacher primarily work with two-stage detectors like Faster R-CNN, MixPL opens the door to semi-supervised learning with single-stage and DETR-based models by integrating mixup and mosaic augmentations with pseudo labels. One or more of the SoftER Teacher, MixTeacher, and/or MixPL methods may follow a student-teacher semi-supervised training paradigm in which the teacher may be an exponential moving average of the student. In the semi-supervised setting, the models may learn from a joint dataset of labeled D_{head} and unlabeled Dᵤ images via the following compound objective:

$${Ψ}_{semi - det} ( {𝒟}_{head} , {𝒟}_{u} ) ← ℒ = {ℒ}_{sup} + {αℒ}_{pseudo} , \qquad ( 2 )$$

where α>0 may control the contribution of the pseudo-label loss derived from unlabeled data. The functional form of L_{pseudo} is the same as Lₛᵤₚ in Equation (1), except the ground truth targets y may be replaced by pseudo targets y\hat{ } as predicted by the teacher model during self-training.

Referring again to FIG. 3B, the second step of a training process may instantiate the tail models for transfer learning by copying the parameters from the pre-trained head models. Let Ψ′_{det}(Dₜₐᵢₗ)←Ψ_{det}(D_{head}) be the supervised tail model and Ψ′_{semi-det}(Dₜₐᵢₗ, Dᵤ)←Ψ_{semi-det} be the semi-supervised counterpart. In certain implementations, the tail models may be trained the same way per Equations (1) and (2), except only the classifier and regressor modules may be updated to adapt them to tail classes, while freezing the rest of the networks. In this implementation, the pre-trained representations may serve as a bootstrapped initializer to train an accurate tail model, according to step 1, as discussed above.

Unlike common head objects, the tail classes may be intrinsically rare without occurrence in either labeled or unlabeled source, which raises a hurdle for training Ψ′_{semi-det} with unlabeled images since there are very few instances of the rare classes in the unlabeled scenes for the teacher model to propose reliable pseudo targets. Certain implementations of the disclosed technology may sidestep this hurdle by copying and pasting a random subset of rare instances from the labeled training set to the unlabeled images, which is a new procedure that is unique to the field. At each training iteration, the teacher model is guaranteed to see an augmented view of sampled rare objects, amid diverse background scenes, which promotes pseudo-label supervision for the student model.

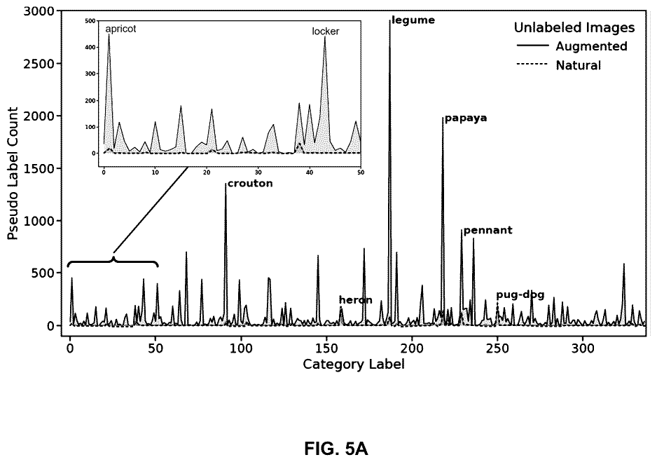

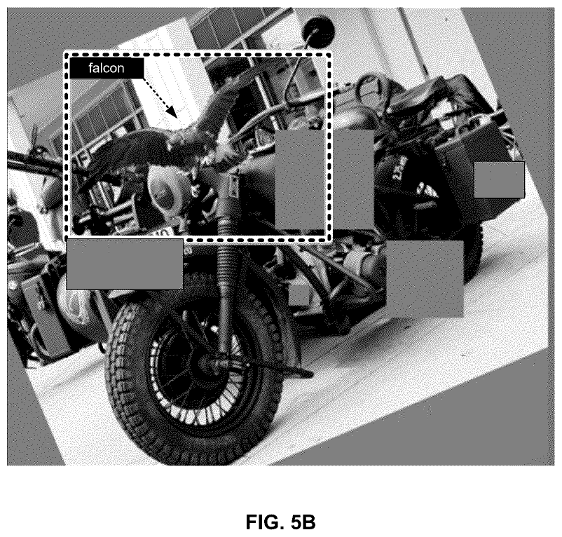

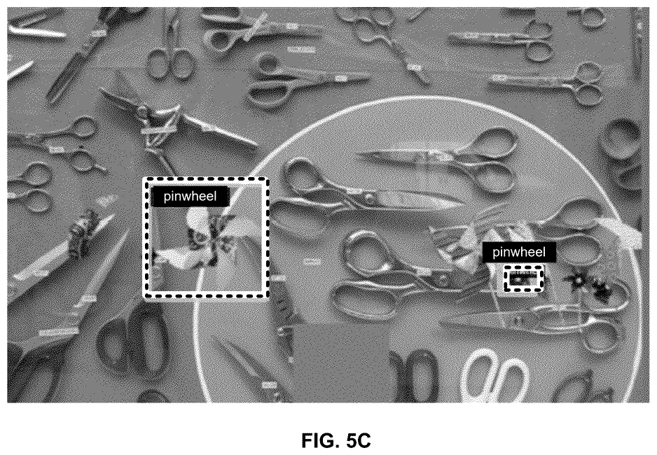

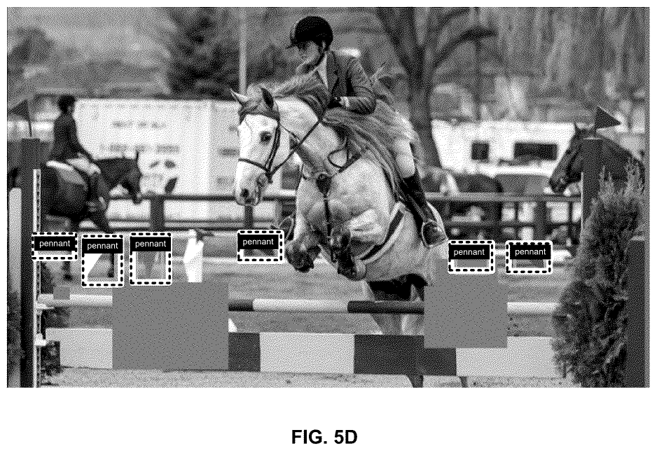

FIG. 5A illustrates the impact of the disclosed technique on pseudo-labeling and illustrates augmenting unlabeled images by randomly pasting rare instances from the training set, which helps promote pseudo-labeling for semi-supervised LTD. FIG. 5B illustrates examples of the augmented unlabeled images, which are subjected to strong photometric and geometric perturbations with cutout. FIG. 5C illustrates additional examples of the augmented unlabeled images, which are subjected to strong photometric and geometric perturbations with cutout. FIG. 5D illustrates that utilization of the rare instances can improve robustness and generalization on natural scenes (boxes). Although the procedures disclosed herein may inevitably lead to redundancy and overfitting, ablation experiments show that it is surprisingly helpful in adapting head representations to the tail models, as will be discussed further below.

Referring again to FIG. 3C, the third step of a training process may utilize two separate models with a shared representation, one optimized on head classes and the other on tail classes. Certain implementations of the disclosed technology may unify the two models into one for efficient single-pass inference on test samples containing both head and tail categories

In accordance with certain implementations of the disclosed technology, the following PyTorch pseudocode may be used for head-tail class merging:

```
# HEAD_IDS : sorted list of head IDs, length 866
# head_ckpt: model checkpoint on head classes
# TAIL_IDS : sorted list of tail IDs, length 337
# tail_ckpt: model checkpoint on tail classes
ALL_IDS = sorted(HEAD_IDS + TAIL_IDS) # length 1203
ID2LABEL = {
    ID: label for label, ID in enumerate(ALL_IDS)
    } # mapping from category ID to integer label
head_det = head_ckpt[“state_dict”][“detector”]
tail_det = tail_ckpt[“state_dict”][“detector”]
fused_det = torch.randn(len(ALL_IDS))
for label, ID in enumerate(HEAD_IDS):
  fused_det[ID2LABEL[ID]] = head_det[label]
for label, ID in enumerate(TAIL_IDS):
  fused_det[ID2LABEL[ID]] = tail_det[label]
head_ckpt[“state_dict”][“detector”] = fused_det
torch.save(head_ckpt, save_filename) # to fine-tune
```

In accordance with certain exemplary implementations of the disclosed technology, parameters at the detector module may be merged, and the pre-trained head representations may be reused for the rest of the network. In certain implementations, the unified detector may be fine-tuned on Dₖ composed of k instances, or shots, per class sampled from the long-tailed training set. In certain implementations, only the box classifier is updated with a regressor with a reduced learning rate to slowly adapt them to tail classes while preserving the pre-trained accuracy on head classes. Analogous to class-incremental learning, the disclosed technology can include both head and tail classes in Dₖ for exemplar replay to avoid catastrophic forgetting. Dₖ may be formed via random sampling, whereas prior work resorted to a complicated scheme of confidence-guided exemplar replay.

In accordance with certain exemplary implementations of the disclosed technology, the disclosed technology may be empirically evaluated using a benchmark on the challenging LVIS v1 dataset, which has 100170 training and 19809 validation images over 1203 classes. A standard LVIS evaluator may be utilized to compute the detection metric mAP_{box} for all classes, without test-time augmentation, along with APᵣ, AP_{c}, and AP_{f} for the rare, common, and frequent categories, respectively. In certain implementations, Dₖ may be sampled three times with different random seeds and the averaged metrics may be reported to capture statistical variability. Comparative analysis of different techniques may be determined by focusing on performance gains of mAP_{box} and APᵣ, which indicate that the disclosed technology exhibits excellent performance and scalability across different backbones, detectors, and unlabeled images.

Models of the disclosed technology have been implemented using PyTorch and MMDetection with training performed on 8×A6000 GPUs. In an example implementation, during Step 1 (as illustrated in FIG. 3A) models may be pre-trained for 540K iterations. In Step 2 (as illustrated in FIG. 3B), the model performing transfer learning may use 20K iterations. In step 3 (as illustrated in FIG. 3C), the model may fine-tune for 80K iterations. In certain implementations, the training can take between 8 hours and 15 days to complete, depending on the scope.

In certain implementations, a high-quality supervised baseline may be constructed by combining the disclosed multistage training with diverse data augmentations. Certain implementations of the disclosed technology can include utilizing various ResNet backbones for both Faster RCNN and DETR-based models. In certain implementations, FPN may be utilized for additional feature extraction with Faster R-CNN. In accordance with certain exemplary implementations of the disclosed technology, the supervised baseline may serve as a basis for the teacher model to generate reliable pseudo targets for semi-supervised learning.

In accordance with certain exemplary implementations of the disclosed technology, one or more of SoftER Teacher, Mix-Teacher, and MixPL may be leveraged for semi-supervised LTD. Certain implementations of the disclosed technology include may inherit all hyper-parameters originally tuned on the COCO dataset without changes. In one example implementation, approximately 123K COCO-unlabeled2017 images may be utilized to improve both representation and transfer learning in Step 1 and Step 2 of the disclosed technology. In certain implementations, Objects365 may be utilized to further validate the approach of the disclosed technology on another related domain with ˜1.7M unlabeled images in the wild by removing all label information from the training set.

In comparing the effectiveness of the disclosed technology against existing methods representing the state of the art on LVIS, a conscientious effort was made to have a fair comparison across multiple dimensions of backbone, detector, and external data source since not all methods follow a single established experimental protocol. The results show that the disclosed technology (SimLTD supervised baseline with Faster R-CNN) outperforms all methods using related detectors. The gains are convincing, with margins up to +4.1 AP_{box} and +5.6 APᵣ. A similar trend is observed when comparing our disclosed supervised baseline technology using Deformable DETR: the disclosed technology is on par with RichSem on AP_{box} while surpassing the competition on APᵣ, including RichSem, with a significant improvement by up to +10.6 APᵣ points.

For the methods requiring external data, certain implementations of the disclosed technology using semisupervised models also deliver impressive performance. For example, when equipped with MixTeacher and Faster R-CNN, the disclosed technology (SimLTD) exceeds the competition by up to +7.9 AP_{box} while being competitive on APᵣ. Furthermore, the disclosed technology scales well by coupling with MixPL and the DINO detector to achieve new state-of-the-art results from harnessing only unlabeled images. Interestingly, the performance difference between COCO and Objects365 unlabeled images is small, signifying that the disclosed technology can exploit meaningful pseudo-label supervision from a large uncurated database with a different distribution than the training dataset.

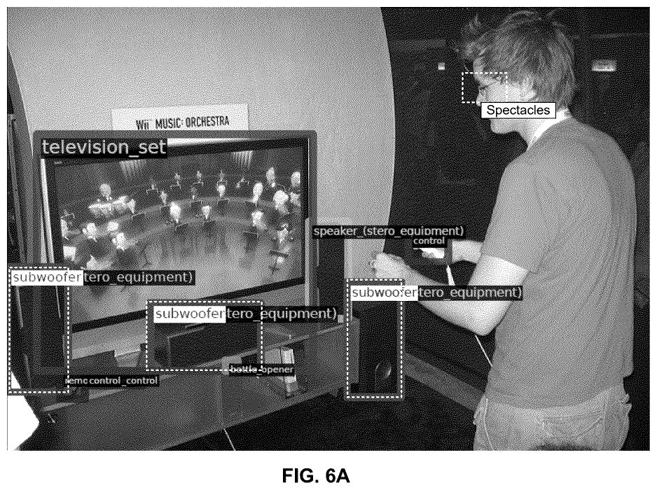

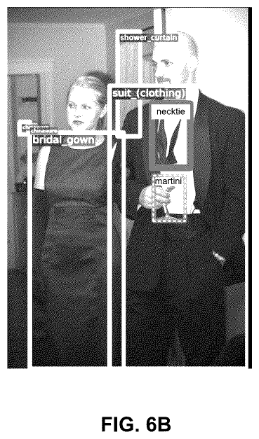

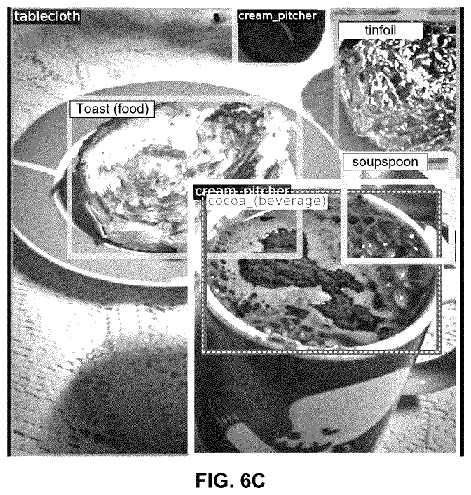

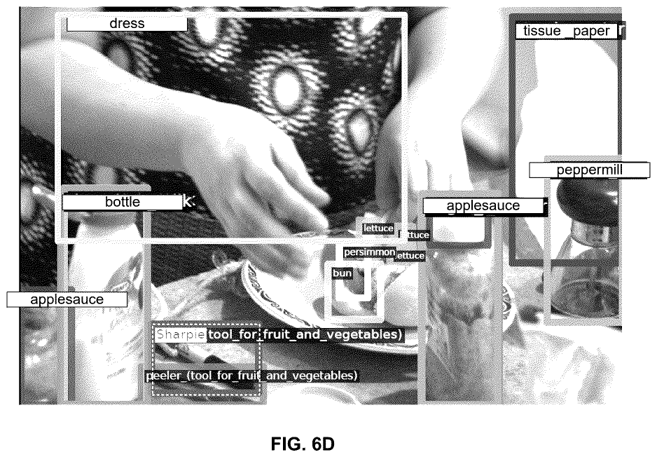

FIG. 6A illustrates detections using the disclosed technology on LVIS v1 validation images for k=1 shot. Visualizations containing truly rare k-shot exemplars (subwoofer equipment in this case) from the training set are highlighted in the dashed-boxes. The disclosed technology performs well in the extremely low-shot regime using as few as a single training instance.

FIG. 6B illustrates detections using the disclosed technology on LVIS v1 validation images for k=3 shots. A visualization containing a truly rare k-shot exemplar (martini in this case) from the training set is highlighted in the dashed-box.

FIG. 6C illustrates detections using the disclosed technology on LVIS v1 validation images for k=4 shots. A visualization containing a truly rare k-shot exemplar (cocoa beverage in this case) from the training set is highlighted in the dashed-box. T

FIG. 6D illustrates detections using the disclosed technology on LVIS v1 validation images for k=5 shots. A visualization containing a truly rare k-shot exemplar (Sharpie pen in this case) from the training set is highlighted in the dashed-box.

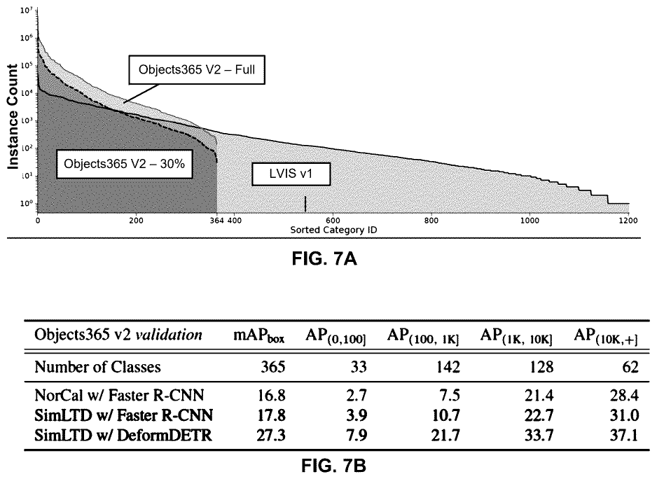

FIG. 7A illustrates the generality of the disclosed framework by an evaluation on Objects365 binned by the count of training images per class group and illustrates. In this example, 30% of the training set was sampled and split it into C_{head}=332 classes appearing in M>100 images and Cₜₐᵢₗ=33 classes appearing in M≤100 images. The evaluation is partitioned into four groups of categories based on the count of training images by category. All models use the ResNet-50 backbone.

As shown in FIG. 7A, there is a large difference of instance counts between LVIS and Objects365, with Objects365 having ˜36× more labels than LVIS for its most abundant object. As summarized in FIG. 7B, the disclosed technology outperforms the existing baseline across the board in the validation results.

In certain implementations, the disclosed technology may be fined tuned using k=30000 shots, a parameter that may change based on the dataset.

When comparing the disclosed technology with CascadeMatch, there are major differences between the two. For example, although both the disclosed technology and CascadeMatch may leverage COCO-unlabeled2017 for semisupervised LTD, CascadeMatch is trained end-to-end in a single stage, whereas the disclosed technology utilizes a decoupled approach. CascadeMatch further adopts the stronger Cascade R-CNN compared to Faster R-CNN that may be used in the disclosed technology. Furthermore, CascadeMatch follows the APFixed protocol, which replaces the standard maximum 300 detections per image by a cap of 10K detections per class from the entire validation set. Despite the disadvantage of a simpler model, Table 2 shows that the disclosed technology (SimLTD) outperforms CascadeMatch by notable margins in almost every measure, which further supports the superiority of the multi-stage training.

TABLE 2

| Method | Base Detector | Backbone | AP_{box}^{fixed} | APᵣ^{fixed} | AP_{c}^{fixed} | AP_{f}^{fixed} |
|---|---|---|---|---|---|---|
| CascadeMatch (Sup) | Cascade R-CNN | R101-FPN | 27.1 | 20.3 | 26.1 | 31.1 |
| FASA (Supervised) | Mask R-CNN | | 28.2 | 22.0 | 28.3 | 30.9 |
| SimLTD Supervised | Faster R-CNN | | 32.7 | 24.9 | 32.9 | 35.9 |
| CascadeMatch | Cascade R-CNN | R50-FPN | 30.5 | 23.1 | 29.7 | 34.7 |
| SimLTD SoftER Teacher | Faster R-CNN | | 31.3 | 24.1 | 31.1 | 34.6 |
| SimLTD MixTeacher | Faster R-CNN | | 32.8 | 24.5 | 32.9 | 36.4 |
| CascadeMatch | Cascade R-CNN | R101-FPN | 32.9 | 26.5 | 31.8 | 36.8 |
| SimLTD SoftER Teacher | Faster R-CNN | | 33.0 | 26.1 | 32.6 | 36.4 |
| SimLTD MixTeacher | Faster R-CNN | | 34.4 | 26.1 | 34.2 | 38.2 |

Further comparisons of the disclosed technology with other techniques have been conducted to determine multi-stage learning performance differences. For example, Dong et al. “Boosting Long-Tailed Object Detection via Step-Wise Learning on Smooth-Tail Data. In ICCV, 2023, utilizes a three-step procedure of pre-training followed by fine-tuning and knowledge distillation. An analysis was conducted with focus on the Deformable DETR model, which yields similar results to the simpler Faster R-CNN model, as utilized in the disclosed technology. When training using the same capable Deformable DETR architecture, results show that the disclosed technology exceeds the model of Dong et al. by outsized margins of +6.3 AP_{box} and +10.2 APᵣ. These remarkable gains may be directly attributed to the multi-stage learning approach of the

[symbol]

outside of generic objects. By contrast, the disclosed technology leverages optional unlabeled images to deliver better performance than RichSem without resorting to either CLIP or auxiliary ImageNet labels. When external data is removed, for example, the disclosed technology substantially outperforms RichSem by +6.0 APᵣ in the fully supervised setting, implying that the success of RichSem may be sensitive to the contributions of CLIP and ImageNet supervision. In contrast, the disclosed technology and framework carries the benefit of being robust across settings with and without external data.

In accordance with certain exemplary implementations of the disclosed technology, the disclosed technology may be considered a multi-stage training strategy combined with standard data augmentations to overcome the class imbalances in both head and tail datasets without complications of previous approaches.

TABLE 3

| Configuration | mAP_{box} | APᵣ |
|---|---|---|
| Single-Stage Training +++Copy-Paste | 28.1 | 16.8 |
| Multi-Stage Baseline (w/Random Resize) | 26.8 | 17.9 |
| Multi-Stage Baseline +Photometric Jittering | 26.9 | 18.2 |
| Multi-Stage Baseline ++Repeat Sampling | 27.1 | 19.3 |
| Multi-Stage Baseline +++Copy-Paste (Ours) | 29.0 | 20.9 |

Table 3 shows ablation experiment results, quantifying the effectiveness of each component in the supervised baseline of the disclosed technology. In accordance with certain exemplary implementations of the disclosed technology, the single-stage model may be trained end-to-end on the whole long-tailed dataset. The contributions of the disclosed technology establish a more robust baseline than was previously possible by using the Faster R-CNN detector with ResNet-50 FPN. These results also showcase the viability of multi-stage learning over the naïve single-stage training procedure on the whole long-tailed dataset, which yields markedly worse results.

As discussed above, certain implementations of the disclosed technology may transfer the pre-trained head representations to optimize on tail classes in Step 2 (as illustrated in FIG. 3B). However, In certain implementations, this step may be optional and may be skipped, because it is possible to initialize the tail classes with random values before finetuning.

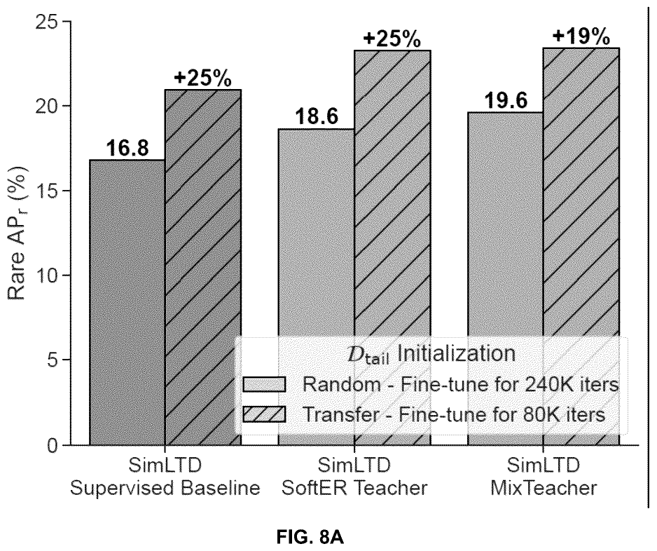

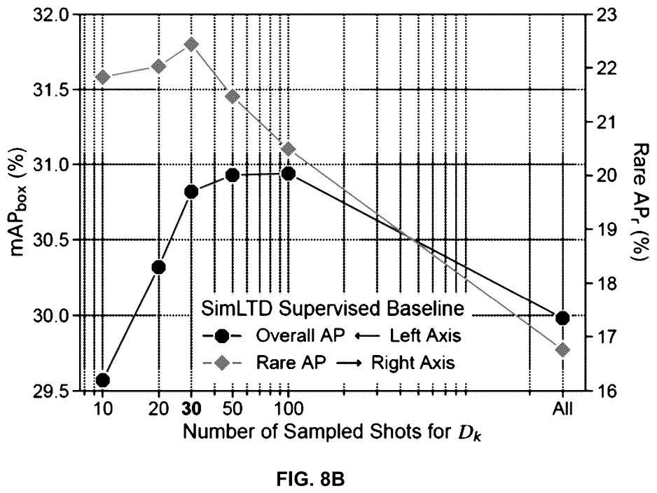

FIG. 8A illustrates ablation experiments assessing the performance impact of the disclosed technology from transfer learning on tail classes, in accordance with certain exemplary implementations.

FIG. 8B illustrates ablation experiments assessing the performance impact of the disclosed technology by varying the number of sampled shots for fine-tuning with Dₖ, in accordance with certain exemplary implementations.

FIGS. 8A and 8B show that transfer learning on tail classes is a worthwhile task. Across both supervised and semisupervised settings, transfer learning gives a boost by up to +4.7 APᵣ and comes with the added bonus of shortening the fine-tuning time by ⅔ of the required iterations.

FIGS. 8A and 8B further illustrate the impact on mAP_{box} and APᵣ as a function of sampled shots for fine-tuning with Dₖ, ranging from 10 to “all” meaning the entire long-tailed training set. The aim of this experiment is to determine how many shots to sample for Dₖ and to optimize for accuracy on rare classes while mitigating catastrophic forgetting on pre-trained head representations. In this example implementation, the “knee in the curve” in FIG. 8B may be analyzed to determine that that 30-shots may balance the trade-off between the two metrics. FIG. 3C, for example, illustrates that with 30-shots, the entire tail distribution may be sampled and may contain 20 or fewer instances per class and include a mixture of head categories for exemplar replay. Thus, for this example, 30-shots may be considered a “sweet spot.’” Referring again to FIG. 8B, when using 10 or 20 shots, marked reductions in mAP_{box}(%) (left scale) is observed, indicating adverse forgetting on head classes from insufficient samples. Additionally, as shown in FIG. 8B, using greater than 30 shots results in precipitous drop in APᵣ (%) (right scale) in response to the overwhelming number of head samples.

FIG. 9 is a flow diagram of a method 900 for long-tailed object detection, in accordance with certain exemplary implementations of the disclosed technology. In block 902, the method 900 includes obtaining a dataset with labeled head classes appearing in more than a threshold number of samples and labeled tail classes appearing in fewer than the threshold number of samples. In block 904, the method 900 includes pre-training a detection model on head class images of the dataset, wherein the detection model comprises a backbone network for feature extraction and a detection head comprising a classifier module and a regressor module for bounding box predictions. In block 906, the method 900 includes augmenting the pre-trained detection model by pseudo-labeling unlabeled images and adapting the detection model to tail classes by initializing tail parameters of the detection model from the pre-trained detection model and fine-tuning with tail class images. In block 908, the method 900 includes fine-tuning the detection model on a balanced dataset comprising both head and tail classes, wherein the fine-tuning updates the classifier module and the regressor module while freezing parameters of the backbone network.

In certain implementations, the detection model may further include a loss function for incorporating classification loss and regression loss.

In certain implementations, the backbone network may be selected from a ResNet family architecture. In certain implementations, the backbone network may be selected from a Transformer-based architecture.

In accordance with certain exemplary implementations of the disclosed technology, the detection head may incorporate a Feature Pyramid Network (FPN) for multi-scale feature extraction.

In certain implementations, the pseudo-labeling may be performed by employing a teacher-student framework, wherein a teacher model may be utilized to generate pseudo-labels for a student model. In certain implementations, the pseudo-labeling may be performed by using a confidence threshold to select reliable pseudo-labels.

In certain implementations, the pseudo-labeling can further include augmenting unlabeled images by one or more of: automatically copying rare instances from labeled images and automatically pasting the copied rare instances onto unlabeled images to create synthetic scenes. In certain implementations, the pseudo-labeling can further include and automatically applying one or more of geometric and photometric transformations. The one or more of geometric and photometric transformations can include one or more of resizing, rotation, translation, and contrast adjustment.

In certain implementations, the pre-training can include training on an imbalanced head dataset using a data sampling strategy or process. In certain implementations, the data sampling strategy or process can include simple copy-paste (SCP) augmentation to generate additional labeled instances for rare head classes. In certain implementations, the data sampling strategy or process can include repeat factor sampling (RFS) to increase representation of underrepresented head classes.

In accordance with certain exemplary implementations of the disclosed technology, the fine-tuning can include freezing the backbone network and updating the classifier and regressor weights of the detection head. In certain implementations, the fine-tuning can include incorporating additional unlabeled data containing rare class instances by augmenting scenes with rare objects. In certain implementations, the fine-tuning can include optimizing a combined loss function. In certain implementations, optimizing the combined loss function can include determining a supervised loss for labeled tail images, and pseudo-labeling loss for unlabeled data.

In accordance with certain exemplary implementations of the disclosed technology, a balanced dataset for fine-tuning can include a subset of head class images sampled randomly based on a pre-determined shot count. In certain implementations, the balanced dataset for fine-tuning can include all available tail class images if a tail portion of the dataset has fewer samples than the shot count.

The disclosed technology provides a simple and versatile framework for supervised and semi-supervised long-tailed detection. Standing out from existing work, the disclosed technology delivers excellent performance and scalability to achieve new state-of-the-art results on the challenging LVIS v1 benchmark, without requiring auxiliary image-level supervision, and can provide improved performance in the problem of long-tailed detection.

Certain implementations of the disclosed technology can be applied to practical applications and use cases that can include one or more of the following: (1) general object detection from images and videos; (2) object detection from aerial imagery; (3) defect detection in manufacturing; (4) pedestrian detection; (5) drone detection; (6) surveillance; (7) face detection and recognition; (8) object detection for self-driving vehicle application; (9) detection for sports analytics; etc. For example, in the practical application use case of aerial imagery for determining the condition of a roof, the presence of roof streaking, marking or deterioration may indicate a related potential current or future problem with a roof. However, available aerial imagery datasets may include only few exemplars of such instances, with a class imbalance between frequent and rare categories. Implementations of the disclosed technology, as discussed herein, may enable utilization of image datasets having few labels to train a model for enhanced recognition on rare instances.

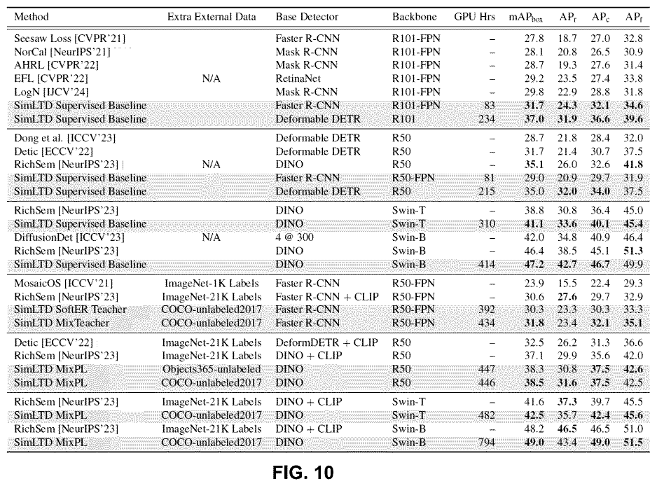

FIG. 10 show results of LVIS v1 validation in accordance with certain exemplary implementations of the disclosed technology. GPU hours denote wall clock time to train for a total of 640K iterations and are a proxy measure of model complexity. The ResNet and Swin backbones were pre-trained on ImageNet-1K and ImageNet-22K, respectively. The results of Seesaw Loss and Detic are borrowed from EFL and RichSem, respectively. Shaded rows indicate the disclosed technology implemented models.

The results listed in FIG. 10 illustrate the effectiveness of the disclosed technology against existing methods representing the state of the art on LVIS. For example, SimLTD supervised baseline with Faster R-CNN outperforms all methods using related detectors. The gains include margins up to +3.9 AP_{box} and +5.6 APᵣ. A similar trend is observed when comparing the disclosed technology supervised baseline using DETR-based models. SimLTD demonstrates compelling performance and scalability across a multitude of backbones and detectors without the need for extra data.

For the methods requiring external data, the disclosed technology of semisupervised models also deliver impressive performance. When equipped with MixTeacher and Faster R-CNN, SimLTD exceeds the competition by up to +7.9 AP_{box} while being competitive on APᵣ. Furthermore, SimLTD scales well by coupling with MixPL and transformer-based models to achieve new state-of-the-art results from harnessing only unlabeled images. SimLTD works equally well with both COCO and Objects365 unlabeled images, signifying that the model can extract meaningful pseudo-label supervision from a large uncurated database with a distribution different from the training dataset.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed:

1. A computer-implemented method for long-tailed object detection, comprising:
obtaining a dataset with labeled head classes appearing in more than a threshold number of samples and labeled tail classes appearing in fewer than the threshold number of samples;
pre-training a detection model on head class images of the dataset, wherein the detection model comprises:
a backbone network for feature extraction; and
a detection head comprising a classifier module and a regressor module for bounding box predictions;
augmenting the pre-trained detection model by pseudo-labeling unlabeled images and adapting the detection model to tail classes by initializing tail parameters of the detection model from the pre-trained detection model and fine-tuning with tail class images; and
fine-tuning the detection model on a balanced dataset comprising both head and tail classes, wherein the fine-tuning updates the classifier module and the regressor module while freezing parameters of the backbone network.

2. The computer-implemented method of claim 1, wherein the detection model further comprises a loss function incorporating classification loss and regression loss.

3. The computer-implemented method of claim 1, wherein the backbone network is selected from a ResNet family or a Transformer-based architecture.

4. The computer-implemented method of claim 1, wherein the detection head incorporates a Feature Pyramid Network (FPN) for multi-scale feature extraction.

5. The computer-implemented method of claim 1, wherein the pseudo-labeling is performed by:
employing a teacher-student framework, wherein a teacher model generates pseudo-labels for a student model; and
using a confidence threshold to select reliable pseudo-labels.

6. The computer-implemented method of claim 1, wherein the pseudo-labeling further comprises augmenting unlabeled images by automatically:
copying rare instances from labeled images;
pasting the copied rare instances onto unlabeled images to create synthetic scenes; and
applying one or more of geometric and photometric transformations.

7. The computer-implemented method of claim 6, wherein applying one or more of geometric and photometric transformations comprises one or more of resizing, rotation, translation, and contrast adjustment.

8. The computer-implemented method of claim 1, wherein the pre-training includes training on an imbalanced head dataset using a data sampling strategy by combining:
simple copy-paste (SCP) augmentation to generate additional labeled instances for rare head classes; and
repeat factor sampling (RFS) to increase representation of underrepresented head classes.

9. The computer-implemented method of claim 1, wherein fine-tuning comprises:
freezing the backbone network and updating the classifier and regressor weights of the detection head;
incorporating additional unlabeled data containing rare class instances by augmenting scenes with rare objects; and
optimizing a combined loss function.

10. The computer-implemented method of claim 9, wherein optimizing the combined loss function comprises:
determining a supervised loss for labeled tail images; and
pseudo-labeling loss for unlabeled data.

11. The computer-implemented method of claim 1, wherein the balanced dataset for fine-tuning comprises:
a subset of head class images sampled randomly based on a pre-determined shot count; and
all available tail class images if a tail portion of the dataset has fewer samples than the shot count.

12. A system for long-tailed object detection, comprising:
a memory storing a dataset with labeled head classes, labeled tail classes, and unlabeled images;
a processing unit executing instructions to:
pre-train a detection model on head class images by optimizing feature extraction and detection head components;
generate pseudo-labels for unlabeled images using a teacher model, wherein the pseudo-labels are filtered based on confidence scores;
augment tail class training data by copying and pasting rare class instances onto diverse background images;
fine-tune the detection model on a balanced dataset including sampled head and tail class images; and
merge and unify head and tail class detection parameters into a single inference model.

13. The system of claim 12, wherein the detection model comprises a Transformer-based architecture, comprising:
an encoder-decoder structure for generating object queries;
multi-scale feature maps to detect objects at varying scales; and
a bounding box regressor and class probability predictor configured to output final detections.

14. The system of claim 12, further comprising a teacher-student framework for pseudo-labeling comprising:
a teacher model updated via exponential moving averages of student model parameters;
a mechanism for applying data augmentations to unlabeled images for robust pseudo-label generation; and
an adaptive weighting factor for pseudo-label loss to balance contributions of labeled and unlabeled data.

15. A non-transitory computer-readable medium storing instructions that, when executed by a processor, cause a system to perform a method of:
obtaining a dataset with labeled head classes appearing in more than a threshold number of samples and labeled tail classes appearing in fewer than the threshold number of samples;
pre-training a detection model on head class images of the dataset, wherein the detection model comprises:
a backbone network for feature extraction; and
a detection head with classifier and regressor modules for bounding box predictions;
augmenting the pre-trained detection model by pseudo-labeling unlabeled images and adapting the detection model to tail classes by initializing tail parameters of the detection model from the pre-trained detection model and fine-tuning with tail class images; and
fine-tuning the detection model on a balanced dataset comprising both head and tail classes, wherein the fine-tuning updates the classifier and regressor modules while freezing parameters of the backbone network.

16. The non-transitory computer-readable medium of claim 15, wherein:
the detection model further comprises a loss function incorporating classification loss and regression loss;
the backbone network is selected from a ResNet family or a Transformer-based architecture; and
the detection head incorporates a Feature Pyramid Network (FPN) for multi-scale feature extraction.

17. The non-transitory computer-readable medium of claim 15, wherein the pseudo-labeling is performed by:
employing a teacher-student framework, wherein a teacher model generates pseudo-labels for a student model; and
using a confidence threshold to select reliable pseudo-labels.

18. The non-transitory computer-readable medium of claim 15, wherein the pseudo-labeling comprises augmenting unlabeled images by:
copying rare instances from labeled images;
pasting the copied rare instances onto unlabeled images to create synthetic scenes; and
applying one or more of geometric and photometric transformations.

19. The non-transitory computer-readable medium of claim 15, wherein the pre-training includes training on an imbalanced head dataset using a data sampling strategy by combining:
simple copy-paste (SCP) augmentation to generate additional labeled instances for rare head classes; and
repeat factor sampling (RFS) to increase representation of underrepresented head classes.

20. The non-transitory computer-readable medium of claim 15, wherein fine-tuning comprises:
freezing the backbone network and updating the classifier and regressor weights of the detection head;
incorporating additional unlabeled data containing rare class instances by augmenting scenes with rare objects; and
optimizing a combined loss function, wherein optimizing the combined loss function comprises:
determining a supervised loss for labeled tail images; and
pseudo-labeling loss for unlabeled data.
